(19) United States
(12) Patent Application Publication
(10) Pub. No.: US 2007/0139442 A1
(43) Pub. Date: Jun. 21, 2007

(54) Coated blending system

(76) Inventor: Karl E. Robinson, Speke (GB)

Correspondence Address: GLAXOSMITHKLINE;CORPORATE INTELLECTUAL PROPERTY, MAI B475, FIVE MOORE DR., PO BOX 13398, RESEARCH TRIANGLE PARK, NC, 27709-3398, US

(21) Appl. No.: 10/527,539

(22) PCT Filed: Sep. 11, 2003
(86) PCT No.: PCT/US03/28690

§ 371 Date: Mar. 11, 2005

Related U.S. Application Data
(60) Provisional application No. 60/410,654, filed on Sep. 13, 2002.

(51) Int. Cl. G09G 5/00

(52) U.S. Cl. 345/629; D24/100

(57) ABSTRACT

A blending system that includes a blending vessel having an internal surface that has at least one layer of a polymeric coating material thereon, and an impeller is disclosed. The polymeric coating material preferably includes a fluorocarbon polymer.

### FIELD OF THE PRESENT INVENTION

The present invention relates generally to blending systems. More particularly, the invention relates to a coated blending system for mixing compositions, particularly, dry powder pharmaceutical compositions.

### BACKGROUND OF THE INVENTION

It is well known that pharmaceutical compositions in the form of a dry powder may advantageously be administered by inhalation to or through the lung of a patient. In inhalation therapy, a pharmaceutical delivery device, such as a dry powder inhaler (“DPI”), is typically employed to deliver a prescribed dose of a pharmaceutical composition and, hence, medicament to the patient. As is well known in the art, in a typical DPI, a dose of the pharmaceutical composition is positioned in an aerosolization chamber, where it is aerosolized and, hence, dispersed into respirable particles by airflow supplied by a pressurized source of gas or by the patient's inspiration effort.

It is further well known that medicament particles deposit in specific areas of the pulmonary system based upon the aerodynamic size of the particles and the flow rate of the fluid within which they are entrained. Typically, with average inhalation flow rates of between 10 and 60 liters per minute, particles having an aerodynamic diameter in the range of 0.5 to 3 μm are suitable for systemic delivery, as these particles deposit selectively in the deep lung. Particles having an aerodynamic diameter in the range of approximately 0.5 to 10 μm, preferably, 1 to 6 μm, and more preferably, 3 to 6 μm are suitable for local lung delivery, as they will deposit in the conductive airways.

Particles having an aerodynamic diameter greater than 10 μm generally deposit in the mouth, throat or upper airways, offering little therapeutic benefit. Particles having an aerodynamic diameter less than 0.5 μm do not settle out of the airflow to deposit in the lungs, and are subsequently respired when the patient exhales.

The effectiveness of dry powder pharmaceutical composition delivery thus depends upon the ability to precisely and reproducibly meter small quantities of medicament into doses. The metering is typically achieved by diluting the medicament in a pharmaceutical composition. Microgram quantities of very potent medicaments can then be precisely metered into milligram sized doses with an acceptable degree of control.

Efforts in the area of meterability have long included the use of excipients, such as milled or micronized lactose. Blending of the excipient(s) and medicament must, however, provide a dry powder pharmaceutical composition that exhibits substantial homogeneity with respect to the medicament and uniformity of particle size distribution. Indeed, the noted criteria are essential to ensure that the correct therapeutic dose of the medicament is delivered to the patient.

Various conventional blending apparatus and systems have been employed in an effort to produce homogenous, uniform dry powder pharmaceutical compositions. Such systems include tumble mixers and high shear impeller design systems.

There are, however, several drawbacks associated with conventional blending systems. A major drawback is, in many instances, the blend components (i.e., medicament(s) and/or excipient(s)) tend to adhere to the inner surfaces of the blending vessel or container during the blending process. As is well known in the art, the adherence of one or more of the blend components during mixing can, and in many instances will, adversely affect the homogeneity of the blend and, hence, pharmaceutical composition produced therefrom. The noted blend component adherence can also adversely affect the medicament dosage delivered to the patient.

It is therefore an object of the present invention to provide a blending system that overcomes the aforementioned disadvantages and drawbacks associated with conventional blending systems.

It is another object of the present invention to provide a blending system that substantially reduces or eliminates blend component adherence or deposition on the inner surfaces of the blending vessel during a mixing process.

It is another object of the invention to provide a blending system the exhibits enhanced chemical resistance.

It is another object of the invention to provide a blending system that produces substantially homogenous pharmaceutical compositions that are suitable for inhalation therapy.

It is yet another object of the invention to provide a blending system that produces pharmaceutical compositions having a high degree of aerosolibility and dispersability.

### SUMMARY OF THE INVENTION

In accordance with the above objects and those that will be mentioned and will become apparent below, the blending system in accordance with this invention comprises a blending vessel having an internal surface, the internal surface having at least one layer of a polymeric coating material, and an impeller. Preferably, the polymeric coating material comprises a fluorocarbon polymer.

In one embodiment of the invention, the fluorocarbon polymer comprises multiples of tetrafluoroethylene (PTFE), fluorinated ethylene propylene (FEP), perfluoroalkoxyalkane (PFA), ethylene terafluoroethylene (ETFE), vinyldienefluoride (PVDF) and chlorinated ethylene tetrafluoroethylene. The fluorocarbon polymer can also be blended with at least one non-fluorocarbon polymer.

In an additional embodiment of the invention, the blending system comprises a blending vessel having a first internal surface, the blending vessel having at least a charge line adapted to transfer a composition to the blending vessel and a discharge line adapted to receive the composition from the blending vessel, the charge line having a second internal surface and the discharge line having a third internal surface, the first, second and third internal surfaces having at least one layer of a polymeric coating material; and an impeller. In the noted embodiment, the polymeric coating material similarly comprises a fluorocarbon polymer that can also be blended with at least one non-fluorocarbon polymer.

The advantages of this invention include the provision of a blending system that (i) substantially reduces or eliminates the adherence of blend components to the blending system internal surfaces during the mixing process and (ii) exhibits superior chemical resistance.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is a partial plan view of a coated blending system, according to the invention.

### DETAILED DESCRIPTION OF THE PREFERRED EMBODIMENT

Before describing the present invention in detail, it is to be understood that this invention is not limited to particularly exemplified method or process parameters as such may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety.

It must also be noted that, as used in this specification and the appended claims, the singular forms “a,” “an” and “the” include plural referents unless the content clearly dictates otherwise.

Further, unless defmed otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

In describing the present invention, the following terms will be employed, and are intended to be defined as indicated below.

Definitions

By the term “medicament”, as used herein, is meant to mean and include any substance (i.e., compound or composition of matter) which, when administered to an organism (human or animal) induces a desired pharmacologic and/or physiologic effect by local and/or systemic action. The term therefore encompasses substances traditionally regarded as actives, drugs and bioactive agents, as well as biopharmaceuticals (e.g., peptides, hormones, nucleic acids, gene constructs, etc.), including, but not limited to, analgesics, e.g., codeine, dihydromorphine, ergotamine, fentanyl or morphine; anginal preparations, e.g., diltiazem; antiallergics, e.g., cromoglycate (e.g., as the sodium salt), ketotifen or nedocromil (e.g., as the sodium salt); antiinfectives, e.g., cephalosporins, penicillins, streptomycin, sulphonamides, tetracyclines and pentamidine; antihistamines, e.g., methapyrilene; anti-inflammatories, e.g., beclomethasone (e.g., as the dipropionate ester), fluticasone (e.g., as the propionate ester), flunisolide, budesonide, rofleponide, mometasone (e.g., as the furoate ester), ciclesonide, triamcinolone (e.g., as the acetonide) or 6α, 9α-difluoro-11β-hydroxy-16α-methyl-3-oxo-17α-propionyloxy-androsta-1,4-diene-17β-carbothioic acid S-(2-oxo-tetrahydro-furan-3-yl) ester; antitussives, e.g., noscapine; bronchodilators, e.g., albuterol (e.g., as free base or sulfate), salmeterol (e.g., as xinafoate), ephedrine, adrenaline, fenoterol (e.g., as hydrobromide), formoterol (e.g. as fumarate), isoprenaline, metaproterenol, phenylephrine, phenylpropanolamine, pirbuterol (e.g., as acetate), reproterol (e.g., as hydrochloride), rimiterol, terbutaline (e.g., as sulfate), isoetharine, tulobuterol or 4-hydroxy-7-[2-[[2-[[3-(2-phenylethoxy) propyl]sulfonyl]ethyl]amino]ethyl-2(3H)-benzothiazolone; adenosine 2a agonists, e.g., (2R,3R,4S,5R)-2-[6-Amino-2-(1S-hydroxymethyl-2-phenyl-ethylamino)-purin-9-yl]-5-(2-ethyl-2H-tetrazol-5-yl)-tetrahydro-furan-3,4-diol (e.g., as maleate); α₄ integrin inhibitors e.g. (2S)-3-[4-({[4-(aminocarbonyl)-1-piperidinyl]carbonyl}oxy)phenyl]-2-[((2S)-4-methyl-2-{[2-(2-methylphenoxy)acetyl]amino}pentanoyl)amino]propanoic acid (e.g., as free acid or potassium salt), diuretics, e.g., amiloride; anticholinergics, e.g., ipratropium (e.g. as bromide), tiotropium, atropine or oxitropium; hormones, e.g., cortisone, hydrocortisone or prednisolone; xanthines, e.g., aminophylline, choline theophyllinate, lysine theophyllinate or theophylline; therapeutic proteins and peptides, e.g., insulin or glucagon. The noted medicaments may also be employed in the form of salts, (e.g., as alkali metal or amine salts or as acid addition salts) or as esters (e.g., lower alkyl esters) or as solvates (e.g., hydrates) to optimize the activity and/or stability of the medicament.

The term “medicament” further includes formulations containing combinations of active ingredients, including, but not limited to, salbutamol (e.g., as the free base or the sulfate salt) or salmeterol (e.g., as the xinafoate salt) or formoterol (e.g., as the fumarate salt) in combination with an anti-inflammatory steroid such as a beclomethasone ester (e.g., the dipropionate), a fluticasone ester (e.g., the propionate), a furoate ester or budesonide.

By the term “pharmaceutical composition”, as used herein, it is meant to mean a combination of at least one medicament and one or more added components or elements, such as an “excipient” or “carrier.” As will be appreciated by one having ordinary skill in the art, the terms “excipient” and “carrier” generally refer to substantially inert materials that are nontoxic and do not interact with other components of the composition in a deleterious manner. Examples of normally employed “excipients,” include pharmaceutical grades of carbohydrates including monosaccharides, disaccharides, cyclodextrins and polysaccharides (e.g., dextrose, sucrose, lactose, raffinose, mannitol, sorbitol, inositol, dextrins and maltodextrins); starch; cellulose; salts (e.g., sodium or calcium phosphates, calcium sulfate, magnesium sulfate); citric acid; tartaric acid; glycine; leucine; high molecular weight polyethylene glyols (PEG); pluronics; surfactants; lubricants; stearates and their salts or esters (e.g., magnesium stearate, calcium stearate); amino acids; fatty acids; and combinations thereof. Examples of suitable “carriers” include water, silicone, gelatin, waxes, and like materials.

By the terms “blend” and “composition”, as used herein, it is meant to mean one or more substances or elements in the form of a powder or liquid or combination thereof. The term “composition” thus includes dry powder pharmaceutical compositions and the aforementioned medicaments.

By the term “mixing”, as used herein, it is meant to mean and include blending, dispersion and emulsifying of a “blend”, “suspension” or “composition”.

By the term “pharmaceutical delivery device”, as used herein, it is meant to mean a device that is adapted to administer a controlled amount of a composition to a patient, including, but not limited to, the Diskus® device disclosed in U.S. Pat Nos. Des. 342,994; 5,590,654, 5,860,419; 5,837,630 and 6,032,666; the Diskhaler™ device disclosed in U.S. Pat. Nos. Des 299,066; 4,627,432 and 4,811,731; the Rotohaler™ device disclosed in U.S. Pat No. 4,778,054; the Cyclohaler™ device by Norvartis; the Turbohaler™ device by Astra Zeneca; the Twisthaler™ device by Scheling Plough; the Handihaler™ device by Boehringer Engelheim; the Airmax™ device by Baker-Norton; and the Dura and Inhaled Therapeutic active delivery systems. Each of the noted “pharmaceutical delivery devices” are incorporated by reference herein.

As will be appreciated by one having ordinary skill in the art, the blending system of the invention substantially reduces or eliminates the disadvantages and drawbacks associated with conventional blending systems. In one embodiment of the invention, the blending system includes a blending vessel having at least one coating material disposed on the inner surface thereof and an impeller. In a further embodiment, the associated feed and discharge lines also have at least one coating material disposed on the inner surfaces thereof.

As discussed in detail herein, the coating material substantially reduces the adherence of the blend components, particularly, the medicament(s) and excipient(s), during the mixing (or blending) process, resulting in substantially homogeneous dry powder pharmaceutical compositions that are particularly suitable for inhalation therapy. The coating material also enhances the chemical resistance of the blending system.

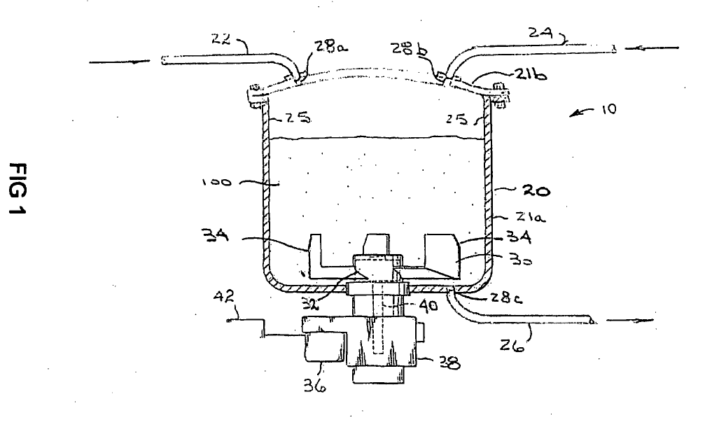

Referring now to FIG. 1, there is shown one embodiment of a coated blending system 10, according to the invention. As will be appreciated by one having ordinary skill in the art, the blending system 10 shown in FIG. 1 is merely one example of a blending system that can include the coated inner surfaces of the invention. Indeed, the coating materials and coated surfaces described herein can readily be incorporated in a multitude of conventional blending vessels and associated components, including feed lines, pumps and valves.

The coating materials and coated surfaces of the invention are also suitable for employment on metallic and plastic receptacles and containers adapted for use in pharmaceuticals and microbiological research and development laboratories. These include sample tubes, centrifuge tubes, reaction flasks and the like.

Referring back to FIG. 1, the illustrated blending system 10 includes a blending (or mixing) vessel 20, having a charge line 22, return (or recirculation) line 24 and a discharge line 26 in communication therewith, an impeller 30, power transmission means (e.g., motor) 36, a drive assembly 38, a rotatable blending system shaft 40 and control means 42. As illustrated in FIG. 1, the impeller 30 includes a hub 32 and a plurality of substantially equally spaced impeller blades 34 attached thereto. The hub 32 is adapted to receive and operatively engage the rotatable shaft 40.

The power transmission means 36 is typically operatively connected to the drive assembly 38, which, in turn, is connected to and rotates the rotatable shaft 40. As stated, the rotatable shaft 40 is adapted to engage the hub 32 of the impeller 30 and, hence, impart rotational energy thereto.

The blending vessel 20 includes a base portion 21a and a lid 21b. The blending vessel 20 also includes conventional ports 28a, 28b, 28c for receiving and discharging the blend 100.

The blending vessel 20 is typically constructed out of aluminum, stainless steel or like material and has a substantially circular shape. The charge line 22, return line 24 and discharge line 26 are similarly typically constructed of stainless steel or like material.

A key feature of the present invention is the deposition of at least one coating material on the inner surface (or wall 25) of at least the base portion 21a of the blending vessel 20. More preferably, at least one coating material is deposited on the base portion 21a and lid 21b. In a further embodiment of the invention, the inner surfaces of the charge line 22, return line 24 and discharge line 26 are similarly coated with at least one coating material.

In additional envisioned embodiments, multiple layers of one coating material or, alternatively, a plurality of different coating materials are disposed on the noted blending system inner surfaces to provide the desired blending system properties and/or characteristics (e.g., thermal resistance, chemical resistance, etc.) during a mixing operation.

In a preferred embodiment of the invention, the coating material comprises a pharmacologically inert polymer, preferably, a fluorocarbon polymer, more preferably, a fluorocarbon polymer comprising multiples of the following monomeric units: tetrafluoroethylene (PTFE), fluorinated ethylene propylene (FEP), perfluoroalkoxyalkane (PFA), ethylene terafluoroethylene (ETFE), vinyldienefluoride (PVDF), and chlorinated ethylene tetrafluoroethylene.

According to the invention, the noted fluorocarbon polymers can also be blended with non-fluorocarbon polymers, such as polyamides, polyimides, polyamideimdie, polyethersulfones and polyphenylene sulfides. As is well known in the art, the added polymers enhance coating adhesion.

Preferably, the coating thickness is in the range of approximately 1 μm to approximately 1 mm. More preferably, the coating thickness is in the range of approximately 5-100 μm.

In a further embodiment of the invention, a barrier material is disposed at the blending system component (e.g., blending vessel 20) surface and coating material interface. According to the invention, various conventional primers can be employed as a barrier material; provided, the primer provides (i) an effective structural bond to the blending system component surface, (ii) an effective hydrolysis and vapor resistant barrier, and (iii) stability at the same service conditions as the coating material(s).

In a preferred embodiment, the barrier material comprises a resin based or polymer mix primer, such as polytetrafluoroethylene and polyethersulphone. More preferably, the barrier material comprises polytetrafluoroethylene.

According to the invention, the blending vessel 20, system components, i.e., lines 22, 24, 26, and associated components, can be coated by the means known in the art of metal coating. For example, a metal, such as aluminum or stainless steel, may be precoated as coil stock and cured before being stamped or drawn.

Another technique for obtaining a coated blending vessel 20 is by spraying the inner surface of the preformed vessel 20 with formulations of the coating material (e.g., fluorinated polymer) and then curing. The coating material may also be formed in situ at the blending vessel walls 25 using plasma polymerization of the fluorocarbon monomers.

As indicated above, the blending system of the invention 10 is capable of producing substantially homogenous dry powder pharmaceutical compositions having a substantially uniform particle size distribution and a high degree of aerosolibility and dispersability. The pharmaceutical compositions are thus particularly suitable for inhalation therapy. Accordingly, a further aspect of the present invention comprises pharmaceutical compositions, including particulate medicament particles (i.e., neat drugs), blended in accordance with the present invention.

It will be appreciated by those skilled in the art that the pharmaceutical compositions blended in accordance with the invention can, if desired, contain a combination of two or more medicaments or components, including combinations of bronchodilatory agents (e.g., ephedrine and theophylline, fenoterol and ipratropium, and isoetharine and phenylephrine formulations).

Other pharmaceutical compositions may contain bronchodilators such as salbutamol (e.g. as the free base or as the sulphate salt), salmeterol (e.g. as the xinafoate salt), formoterol or isoprenaline in combination with an anti-inflammatory steroid such as a beclomethasone ester (e.g. the dipropionate) or a fluticasone ester (e.g. the propionate) or a bronchodilator in combination with an antiallergic such as cromoglycate (e.g. the sodium salt). A particularly preferred combination is a combination of fluticasone propionate and salmeterol, or a salt thereof (particularly the xinafoate salt). A further combination is budesonide and formoterol (e.g., as the fumarate salt).

It is to be understood that the present invention covers each of the noted medicaments and compounds, all physiologically acceptable derivatives thereof, and all combinations of particular and preferred groups described hereinabove. The term “physiologically acceptable derivative”, as used herein, refers to any physiologically acceptable derivative of a compound of the present invention, for example, an ester, which upon administration to a mammal, such as a human, is capable of providing (directly or indirectly) such a compound or an active metabolite thereof. Such derivatives are clear to those skilled in the art, without undue experimentation, and with reference to the teaching of Burger's Medicinal Chemistry And Drug Discovery, 5th Edition, Vol 1: Principles And Practice, which is incorporated herein by reference.

The pharmaceutical compositions blended in accordance with the invention can conveniently be filled into a bulk storage container, such as a multi-dose reservoir, or into unit dose containers such as capsules, cartridges or blister packs, which may be used with an appropriate pharmaceutical delivery device, for example, as described in GB2041763, WO91/13646, GB1561835, GB2064336, GB2129691 or GB2246299, which are incorporated by reference herein. The noted devices and aforementioned pharmaceutical delivery devices containing a pharmaceutical composition blended in accordance with the invention are deemed novel and, hence, form a further aspect of the invention.

The pharmaceutical compositions formed in accordance with the invention are particularly suitable for use with multi-dose reservoir-type devices in which the composition is metered, e.g., by volume from a bulk powder container into dose-metering cavities. The lower limit of powder delivery, which may be accurately metered from a multi-dose reservoir-type device, is typically in the range of 100 to 200 micrograms. The noted pharmaceutical compositions are therefore particularly advantageous for highly potent and, hence, low dose medicaments that require a high ratio of excipient for use in a multi-dose reservoir-type device.

### SUMMARY

From the foregoing description, one of ordinary skill in the art can easily ascertain that the present invention provides several significant advantages. Among the advantages is the provision of a blending system that substantially reduces or eliminates the adherence of blend components during the mixing process, which results in substantially homogenous pharmaceutical compositions. A further advantage is the provision of a blending system having superior chemical resistance.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

What is claimed is:

1. A blending system for mixing a composition, comprising:
a blending vessel having an internal surface, said internal surface having at least one layer of a polymeric coating material; and
an impeller.

2. The blending system of claim 1, wherein said polymeric coating material comprises a fluorocarbon polymer.

3. The blending system of claim 2, wherein said fluorocarbon polymer comprises multiples of tetrafluoroethylene (PTFE), fluorinated ethylene propylene (FEP), perfluoroalkoxyalkane (PFA), ethylene terafluoroethylene (ETFE), vinyldienefluoride (PVDF) and chlorinated ethylene tetrafluoroethylene.

4. The blending system of claim 3, wherein said fluorocarbon polymer is blended with at least one non-fluorocarbon polymer.

5. The blending system of claim 4, wherein said non-fluorocarbon polymer is selected from the group consisting of polyamides, polyimides, polyamideimdie, polyethersulfones and polyphenylene sulfides.

6. The blending system of claim 1, wherein said layer of polymeric coating material has a thickness in the range of approximately 1 μm to approximately 1 mm.

7. The blending system of claim 6, wherein said coating material thickness is in the range of approximately 5-100 μm.

8. The blending system of claim 1, wherein a barrier material is disposed at the interface of said blending container internal surface and said layer of polymeric coating material.

9. The blending system of claim 8, wherein said barrier material comprises a primer selected from the group consisting of polytetrafluoroethylene and polyethersulphone.

10. A blending system for mixing a composition, comprising:
a blending vessel having a first internal surface, said blending vessel having at least a charge line in communication with said blending vessel adapted to transfer said composition to said blending vessel and a discharge line in communication with said blending vessel adapted to receive said composition from said blending vessel, said charge line having a second internal surface, said discharge line having a third internal surface, said first, second and third internal surfaces having at least one layer of a polymeric coating material; and
an impeller.

11. The blending system of claim 10, wherein said polymeric coating material comprises a fluorocarbon polymer.

12. The blending system of claim 11, wherein said fluorocarbon polymer comprises multiples of tetrafluoroethylene (PTFE), fluorinated ethylene propylene (FEP), perfluoroalkoxyalkane (PFA), ethylene terafluoroethylene (ETFE), vinyldienefluoride (PVDF) and chlorinated ethylene tetrafluoroethylene.

13. The blending system of claim 12, wherein said fluorocarbon polymer is blended with at least one non-fluorocarbon polymer.

14. The blending system of claim 13, wherein said non-fluorocarbon polymer is selected from the group consisting of polyamides, polyimides, polyamideimdie, polyethersulfones and polyphenylene sulfides.

15. The blending system of claim 10, wherein said layer of polymeric coating material has a thickness in the range of approximately 1 μm to approximately 1 mm.

16. The blending system of claim 15, wherein said coating material thickness is in the range of approximately 5-100 μm.

17. The blending system of claim 1, wherein a barrier material is disposed at the interface of said first, second and third internal surfaces and said layer of polymeric coating material.

18. The blending system of claim 17, wherein said barrier material comprises a primer selected from the group consisting of polytetrafluoroethylene and polyethersulphone.

19. A blending vessel, comprising:
a container adapted to receive a composition, said container having an internal surface, said internal surface having at least one layer of a polymeric coating material.

20. The blending vessel of claim 19, wherein said polymeric coating material comprises a fluorocarbon polymer.

21. The blending vessel of claim 20, wherein said fluorocarbon polymer comprises multiples of tetrafluoroethylene (PTFE), fluorinated ethylene propylene (FEP), perfluoroalkoxyalkane (PFA), ethylene terafluoroethylene (ETFE), vinyldienefluoride (PVDF) and chlorinated ethylene tetrafluoroethylene.

22. The blending vessel of claim 21, wherein said fluorocarbon polymer is blended with at least one non-fluorocarbon polymer selected from the group consisting of polyamides, polyimides, polyamideimdie, polyethersulfones and polyphenylene sulfides.

23. The blending vessel of claim 19, wherein said layer of polymeric coating material has a thickness in the range of approximately 1 μm to approximately 1 mm.

24. The blending vessel of claim 23, wherein said coating material thickness is in the range of approximately 5-100 μm.

25. The blending system of claim 19, wherein a barrier material is disposed at the interface of said blending container internal surface and said layer of polymeric coating material.

26. The blending system of claim 24, wherein said barrier material comprises a primer selected from the group consisting of polytetrafluoroethylene and polyethersulphone.
